(19) United States
(12) Patent Application Publication
(10) Pub. No.: US 2007/0274482 A1
(43) Pub. Date: Nov. 29, 2007

(54) Utilizing one telephone account to complete calls made from a different account

(75) Inventors: Rimas Rauba, Roswell, GA (US); Gonzalo Salazar, Alpharetta, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/430,072

(22) Filed: May 8, 2006

(51) Int. Cl. H04M 15/00

(52) U.S. Cl. 379/114.03

(57) ABSTRACT

Telephone calls made from a first account, such as a wireless or wireline account, are completed by bridging the call into a second telephone account, such as a different wireless or wireline account, from which the destination is ultimately reached. Benefits associated with the second telephone account from which the call is completed are applicable even though the call originated from the first account. When bridging into the second account, an identification is provided to a bridging platform. The identification may include a number automatically submitted in response to placing the call into the platform such as a mobile identification number of a wireless device or an automatic number identification, and/or the identification may include a personal identification code manually submitted by the calling party. The identification is looked-up to find the corresponding second telephone account so that the call can be completed to the destination from the platform based on use of the second telephone account that has been found.

### TECHNICAL FIELD

The present invention is related to making telephone calls. More particularly, the present invention is related to making telephone calls from one account while utilizing a different telephone account to complete the telephone calls.

### BACKGROUND

Telephone calls may be placed from wireline or wireless telephone accounts. However, certain limitations may be placed on a wireline or wireless telephone account that either prevents certain calls from being made or that results in a fee for certain calls being unacceptably high. For example, a user of a telephone account, either wireless or wireline, may not be able to make international telephone calls because such calls are prohibited on the telephone account. This is often the case for wireless telephone accounts, and for accounts where such international calls are not blocked, the per-minute fee maybe relatively high such that making the call is undesirable.

While the limitations may be imposed on certain telephone accounts, particularly for international calls from wireless accounts, the calling party may have other telephone accounts where such limitations are not imposed. For example, a user of a wireless telephone account that blocks international calls may have a wireline telephone account that does not block such calls. However, the user may need to place the international call when away from the location associated with the wireline telephone account such that the user cannot benefit from the convenience of the wireline telephone account. Likewise, a user of a wireless telephone account that allows domestic long distance or other calls at no charge may also have a wireline telephone account that charges a fee for such domestic long distance or other calls.

### SUMMARY

Exemplary embodiments address these issues and others by providing for the completion of a call using a first telephone account where the call is being made from a different account. Both the first telephone account and the different account may be wireless telephone accounts or wireline telephone accounts or some combination thereof, including pre-paid accounts and/or post-paid accounts. The calling party calls via the first telephone account into a platform that bridges the calling party into the second account and the desired call is completed through that bridge into the second account as if the calling party had made the call directly from the second account. Accordingly, fees and services of the second account are made applicable for the call being placed from the first account.

One exemplary embodiment is a computer readable medium containing instructions that perform acts comprising receiving an identification of a first account for a current telephone call. A look-up of the identification is performed within a table that relates the identification of the account to a second account. A parameter of the current call is determined, and a fee for the current call is determined based on the parameter and a fee schedule of the second account that relates parameters to fees.

Another exemplary embodiment is a call processing platform that includes a storage device comprising a table relating identification information of a first telephone account to a second telephone account. A processing system receives identification information of the first account from an incoming telephone call placed from a telephone device, looks-up the identification information within the table to find the corresponding second telephone account, and receives a destination number for the incoming call. The processing system also generates a request to complete the incoming call to the destination number upon finding the corresponding second account, monitors a parameter of the incoming call that is completed to the destination number, and determines a fee for the incoming call that is completed to the destination based on the parameter and a fee schedule for the second telephone account.

Another exemplary embodiment is a computer readable medium containing instructions that perform acts comprising bridging a call from a phone line associated with a first account to a destination number. The bridging of the call to the destination number is associated with a second telephone account different than the first account. A parameter of the call is determined, and the second telephone account associated with the bridging of the call is billed based on the parameter and a fee schedule for calls placed from the second telephone account.

### DESCRIPTION OF THE DRAWINGS

FIG. 1 shows an operating environment for exemplary embodiments.

FIG. 2 shows an example of the components of an exemplary embodiment of a bridging platform.

FIG. 3 shows an example of a call flow from the perspective of a calling party according to an exemplary embodiment.

FIGS. 4A and 4B show an example of an operational flow of an exemplary embodiment of a bridging platform.

FIG. 5 shows an example of a wireline telephone account billing statement.

FIG. 6A shows an example of a first screenshot for setting up one exemplary embodiment of an account bridging service.

FIG. 6B shows an example of a second screenshot for setting up one exemplary embodiment of an account bridging service.

### DETAILED DESCRIPTION

Exemplary embodiments disclosed herein provide for callers to place a call from one account and be bridged into a different account, e.g., a wireline account, from which the call to a destination is completed. The benefits of the second account are then applicable to the call to the destination for the calling party, including the fee for the call being based on the fee schedule of the second account. Accordingly, callers may bypass calling restrictions or relatively high fees associated with calling the destination directly through the first account associated with the calling device by instead calling into the bridging service.

Although the description that follows is directed to bridging calls placed from a wireless account to a wireline account for ease of explanation, it will be appreciated that the invention is not so limited but may include bridging calls from one account of any type (e.g., wireless or wireline) to any type of second account (e.g., wireless or wireline) having less restrictions than the account from which the call was placed, e.g., calls may be bridged from one wireless account to another, from a wireline account to a wireless account, etc. Furthermore, the accounts may be pre-paid accounts, post-paid accounts, or any combination thereof.

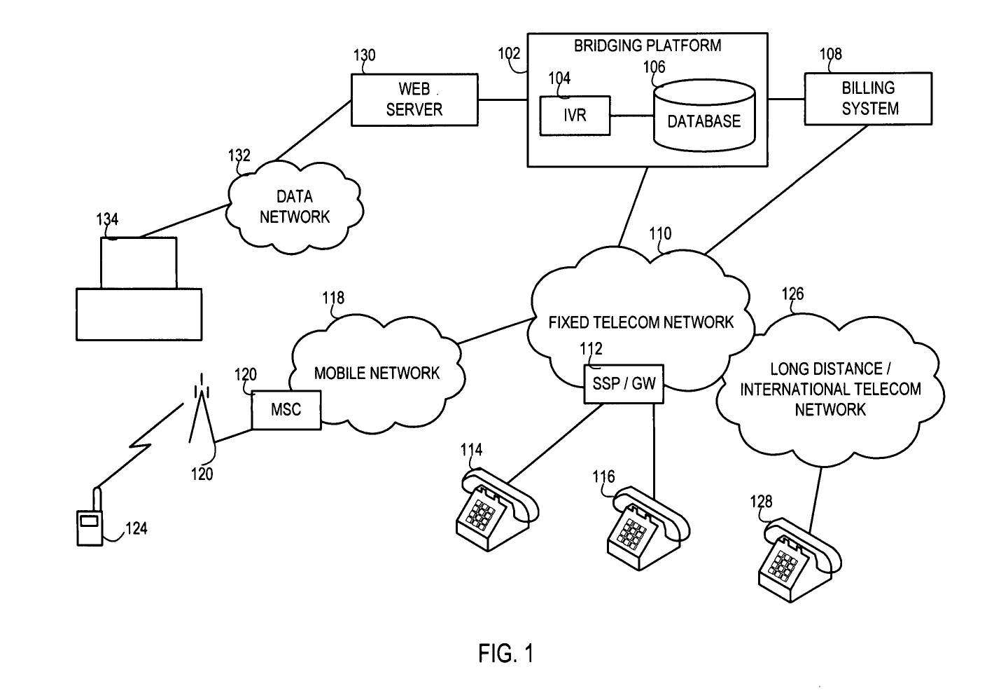

FIG. 1 shows an operating environment where callers attempt to make calls from one communication device associated with one account to a destination telephone line. For example, a caller may be using a mobile communication device 124 to attempt to call a party on a telephone line with associated telephone 128. The caller is provided communication service for the mobile device 124 through a mobile telecommunications network 118, which in this example includes a mobile switching center 120 in communication with a base station 122. During a normal call, the mobile network 118 may then connect the call from the mobile device 124 to a called destination, such as another mobile device on the same or a different mobile network or to a fixed device over a wireline network. Examples of the mobile communication network 118 include CDMA networks, GSM networks, and so forth.

As another example, a caller may be using a fixed telephone device 114 associated with a wireline network such as fixed telecommunications network 110. Examples of a fixed telecommunications network 110 includes a plain old telephone service (POTS) network, and advanced intelligent network (AIN), a voice-over Internet Protocol (VoIP) network, and so forth. The telephone device 114 communicates with a switch, such as a service switching point or softswitch gateway 112 of the network 110. During a normal call, the network 110 then connects the telephone device 114 to the destination, such as another fixed device on the same or a different wireline network or a wireless mobile device on a mobile network. Examples of such destinations include the mobile communication device 124, a fixed wireline device on the same wireline telephone networks, or a fixed wireline device 128 on a separate telephone network 126. The destination may be either a network that is a domestic local call, domestic long distance call, or international long distance call from the wireline telephone 114.

The caller using the mobile device 124 or the wireline telephone 114 may also have a relationship with a wireline phone account for the telephone line associated with wireline telephone 116 of the telecommunications network 110. For use of the mobile device 124 or wireline telephone 114, restrictions may be placed on the ability to make certain calls, such as long distance calls or international calls to the telephone line of telephone device 128. Thus, as opposed to the caller attempting to place a normal call directly to the destination device 128, the caller instead dials a number associated with a bridging service provided by a bridging platform 102 of the wireline telephone network 110. The bridging service then completes the call to the destination through the wireline account associated with telephone 116 and bridges together the caller and the destination.

The bridging platform 102 includes an interface that provides for a degree of interaction with the calling party and/or the network through which the call has been placed in order to authorize the use of the wireline account for the call and/or to determine the destination telephone number. An example of such an interface is an interactive voice response (IVR) unit 104 which provides voice prompts to the caller and allows the caller to either enter touch tone keys or speak commands in order to provide the needed information for authentication and call completion. The bridging platform 102 also maintains a database of relationships between an identification of the account from which the call is being placed, such as a mobile identification number (MIN) of the device 124 or an automatic number identification (ANI) of the telephone line of telephone 114, and the wireline telephone account of the telephone line associated with telephone 116 to be used to complete the call.

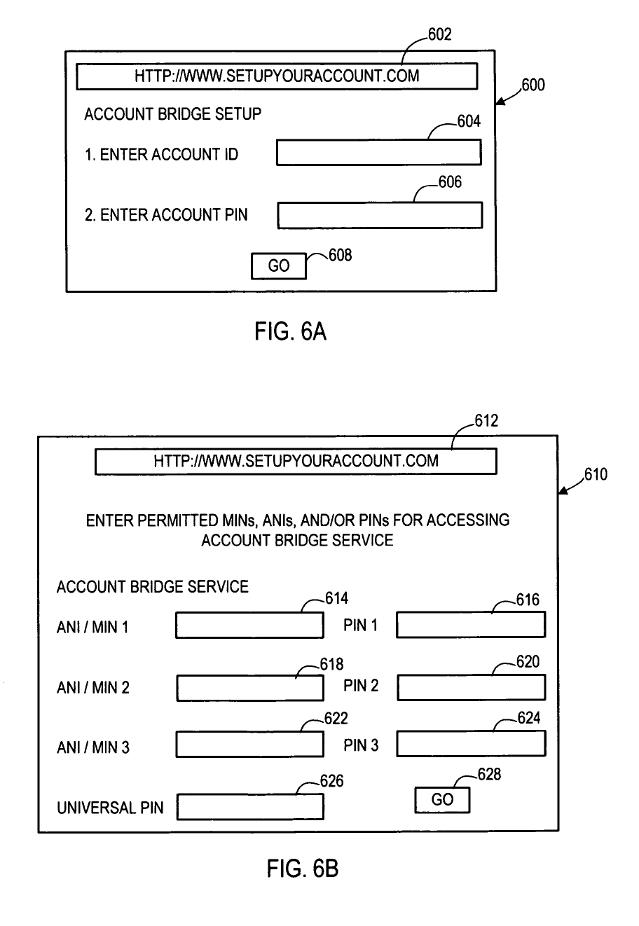

To initially setup the bridging service for a particular wireline account, the user of the wireline account may interact with the bridging platform in one of various manners, such as by using an automated voice or web interface of speaking with a live attendant. For example, the user may place a call to the IVR 104 and choose a setup option that may be provided to callers. The calling party may then specify which MINs, ANIs, and personal identification codes are authorized to use the wireline account. Where a personal identification code is being used alone, the IVR 104 may require that the calling party provide a personal identification code that is unique relative to the personal identification codes of all other subscribers to the bridging service so that the personal identification code singles out one wireline account. Where the setup call to the IVR is made from the wireline account to be used in the bridging service, the IVR receives that ANI of the incoming call which can be used to identify the account. As another example, the user may utilize a computing device such as a personal computer 134 to log on to a web site via a data network 132 such as the Internet. The web site may be provided by a web server 130 in communication with the bridging platform 102 where the web site allows for association of the account to be used to complete calls with all of the MINs, ANIs, and/or PINs desired by the user. FIGS. 6A and 6B, discussed in more detail below, provide examples of such interaction via a web server 130.

Additionally, the service provider operating the telecommunications network 110 utilizes a billing system 108 as a part of the whole call processing system to track the destination and duration of calls made through the wireline telephone accounts of the network 110 in order to generate bills to the account holder. The billing system 108 tracks these parameters of the calls completed by the bridging platform 102 so that the wireline account associated with the telephone line of telephone 116 is billed for the calls that are originating from device 124 or telephone 114 and that are being completed to another destination device 128.

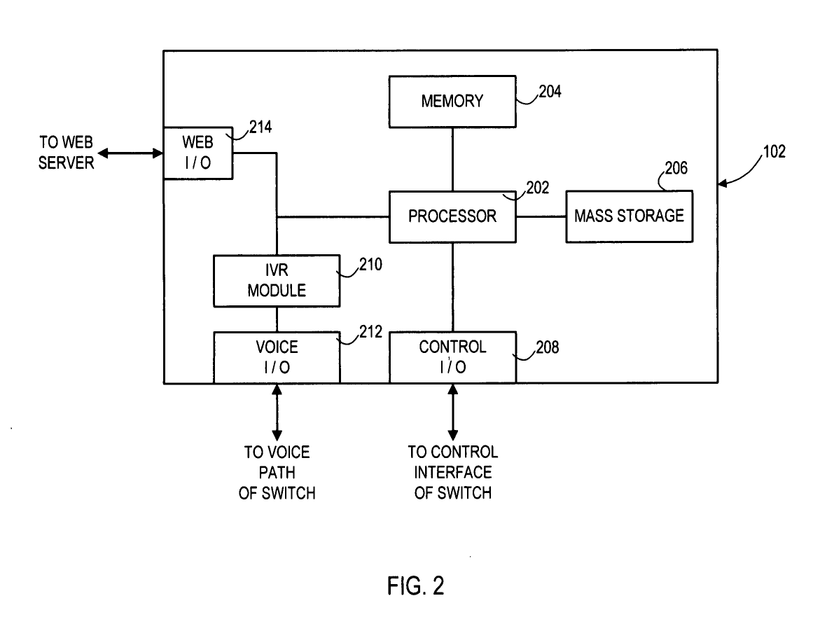

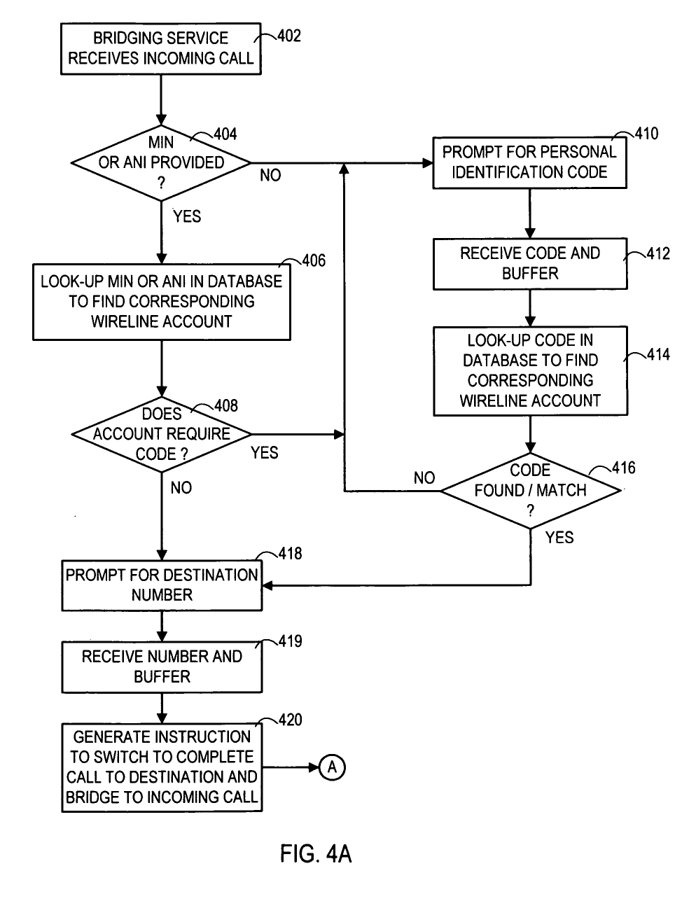

FIG. 2 shows components of one exemplary embodiment of a bridging platform 102. The platform 102 includes a processor 202 that is configured to perform various call processing operations such as those discussed below in relation to FIGS. 4A and 4B. The processor 202 may be a general purpose programmable processor that implements instructions contained in electronic memory 204 to perform the logical operations. As an alternative, the processor 202 may be an application specific processor with hardwired logic instructions. In either case, the processor 202 implements instructions contained within a computer readable medium in order to provide the bridging platform functions. A computer readable medium includes encoded instructions and may be of various forms including volatile or non-volatile electronic storage medium, magnetic or optical storage medium, or a communication medium such as a wired or wireless connection.

The processor 202 may access information from mass storage 206, such as one or more local or networked storage drives. The mass storage 206 may maintain programming instructions that the processor 202 obtains and places into memory 204 from which they are executed. The mass storage 206 may further contain the database discussed in relation to FIG. 1 that associates the identification of the calling party to a wireline telephone account to be used to complete the call to the destination number.

In order for the bridging platform 102 to receive calls from a calling party and then bridge the calling party into the wireline account for purposes of completing the call, the bridging platform 102 may maintain both a voice path into the telecommunications network 110 and a control signal path. The bridging platform 102 maintains a voice path input/output interface 212 that allows the bridging platform to receive voice, dual tone multi-frequency (DTMF), or other voice path signals from the calling device. Accordingly, the bridging platform may receive voice of touch tone commands from the calling party. These voice path signals may be converted to data recognizable by the processor 202 by a module 210, such as an IVR module that converts speech or tones to data. Likewise, the module 210 may convert data into speech that is provided back to the calling party to greet and/or instruct the calling party upon calling into the bridging service. As discussed below, the calling party may be prompted to enter a personal identification code, a destination number, and so forth and the module receives this information over the voice path and provides the representative data to the processor 202 for implementation in the call processing logic.

Additional information may also be received through the voice path such as the MIN or ANI of the calling party. In that case, the module 210 may decode this information from the voice path and provide it to the processor 202 for use in authenticating the calling party and finding the appropriate wireline account. As an alternative to the MIN or ANI, the bridging platform 102 may request a personal identification code in order to authenticate the calling party and find the appropriate wireline account. For example, the calling party may place a call from a mobile device through an early generation mobile network or through a roaming network that does not pass the MIN. The personal identification code may also be requested, even when the MIN or ANI is received, as an additional level of security to prevent unauthorized use of the wireline account for call completion purposes. The personal identification code may be a series of numbers, symbols, and/or letters.

Upon the processor 202 authorizing the calling party, the processor 202 then utilizes the destination number to be reached in order to complete the call over the wireline account. The destination number may be a domestic local number, a domestic long distance number, or even an international long distance number. The destination number may be obtained from the calling party in various ways. For example, the calling device may have two-stage dialing capabilities whereby the caller dials the number for the bridging platform as the first stage of dialing and then the destination number as the second stage. The bridging platform 102 is reached from the first stage and then listens via the voice path for the dialed tones during the second stage. As one alternative, the caller may initially dial the number for the bridging service, then the bridging platform may prompt the user to dial the destination number, such as by providing a voice prompt or creating an in-call dial tone over the voice path to the calling device.

Once the call is authorized and the destination number is obtained, the processor 202 then communicates with a switch of the telecommunications network, such as the switch through which the call was directed to the bridging platform 102, to instruct the switch to place a call to the destination number. The processor 202 further instructs the switch to bridge together the call from the calling party to the outgoing call to the destination number. Once bridged, the bridging platform 102 can be removed from the voice path of the bridged call to free the resources of the bridging platform 102 for other bridging service calls. In order to instruct the switch, in this exemplary embodiment the processor 202 communicates through a control input/output interface 208, such as a signaling system 7 interface where the telecommunications network is an AIN. It will be appreciated that other interfaces may be used other than an SS7 interface, such as a TCP/IP interface for embodiments where an IP network interconnects the bridging platform 102 to the switch.

The bridging platform 102 may also include a web server interface 214 which allows the bridging platform 102 to interact with a web server 130. The web server 130 may provide information to the processor 202 during account setup, including the account identifier entered by the user, a PIN entered by the user for the account identifier, and so forth. Furthermore, the web server 130 may provide information including the MINs, ANIs, and/or PINs relevant to the bridging service of a particular account identifier entered by the user. The processor 202 may create a table in the database 106 that relates the account identified by the user with the MINs, ANIs, and/or PINs that are also entered to create the necessary associations to be used when determining whether an attempt to use the bridging service is valid.

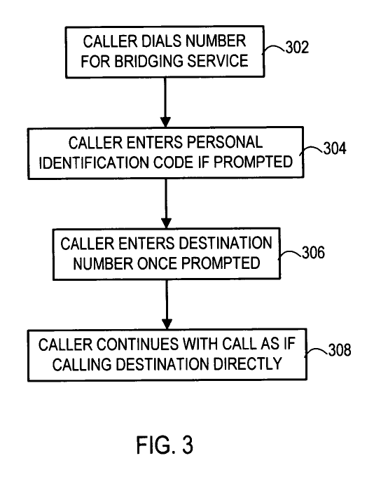

FIG. 3 shows the logical operations of the call flow from the perspective of the calling party according to one exemplary embodiment. The caller initially dials the number for the bridging service at call operation 302. Upon being connected, the caller may be prompted to enter a personal identification code, such as where the MIN or ANI is not passed through or where the personal identification code is used for additional security. If prompted, the caller enters the personal identification code, such as by speaking or dialing the digits at code operation 304. Then, the caller may be prompted for the destination number if two-stage dialing was not employed to already transfer it. The caller enters the destination number, such as by speaking or dialing the digits at destination operation 306. Thereafter, the call is bridged to the call that has been placed by the bridging platform 102 to the destination number. At that point, the call proceeds as if the caller had directly dialed the destination number from the calling device, with all the benefits as if the call had been placed from the telephone of the wireline account.

FIGS. 4A and 4B show the logical operations of the call flow processing performed by an exemplary embodiment of the bridging platform. The bridging service receives the incoming call from a calling party at call operation 402. The telephone number used to reach the bridging service may be a toll-free call so that the calling party is not discouraged from using the service where the call from the calling device would otherwise be a long-distance call. There may also be other alternative numbers to call to the bridging service such as a star code. The telecommunications network associated with the bridging platform routes the incoming call to the bridging platform in response to a caller placing a call to the corresponding telephone number of the bridging service.

Upon receiving the call, the bridging platform determines whether a recognizable account identifier, e.g., MIN or ANI, was provided in the incoming call at query operation 404. If so, then the calling party or device has been identified such that the associated wireline account to be used to complete the call to the ultimate destination can be found at look-up operation 406. Here, the identification information such as the MIN or ANI is referenced within the database to find the corresponding wireline account, which may be identified by the Billing Telephone Number (BTN) of that wireline account.

When the bridging service for the wireline account is initially established, the user may specify which MINs or ANIs are to be associated with the wireline account for use of the bridging service. Additional MINs or ANIs may be later added. A single wireline account may have several different MINs or ANIs associated with it. For example, a single household may have two or more mobile phones and each mobile phone's MIN may be authorized for the bridging service using the wireline account of the household. As another example, a single household may have one or more ANIs and/or MINs separate from the ANI of the wireline account of the household, such as where children of the household live away from home and have their own ANI.

Upon finding the account, query operation 408 determines whether this particular wireline account requires that a personal identification code be provided in order to use the wireline account to complete the call. Certain customers may prefer that such a code be provided as added security while other customers may prefer that such a code not be required as a matter of convenience. If the code is required for the current account, then operational flow proceeds to prompt operation 410. The code may be set at the time the bridging service is established or at a later time, and the code may be the same or different for each of the MINs or ANIs associated with the wireline account. Furthermore, in some cases accounts may utilize only a personal identification code as the manner of finding the proper wireline account so that the caller can utilize the service regardless of where the call is originating from. If the code is not required, operational flow proceeds to prompt operation 418.

Returning to query operation 404, if a recognizable MIN or ANI did not pass through such that the calling party or device is not identifiable, then operational flow proceeds to prompt operation 410. A recognizable MIN or ANI may not pass through due to limitations of the networks involved in completing the connection to the bridging service. Furthermore, a MIN or ANI may pass through, but it may not be recognizable by the service because the MIN or ANI has not been associated with a wireline account. For example, a caller who is authorized to use the bridging service for the wireline account may place a call from a non-associated device or location, such as from a wireline phone or mobile phone of a third party.

Once at prompt operation 410 through either path of the logical operations, the bridging platform prompts the caller to enter the personal identification code that has been established for the account. The personal identification code is received and buffered at receive operation 412. Then, the personal identification code can be looked-up in the database at look-up operation 414. The look-up can be for the purpose of finding a corresponding wireline account where no previous identification data has been received. Alternatively, the look-up can be for the purpose of verifying that the personal identification code that is received matches the personal identification code stored for the wireline account that has already been looked-up on the basis of the recognizable identification information that has already been received.

Query operation 416 detects whether the received personal identification code has been found at all, where looking up the code to find a corresponding wireline account, or whether the received personal identification code is a match to the stored personal identification code for the wireline account that has already been found. If there is no match for the received code, then operational flow returns to prompt operation 410 where the bridging service prompts the caller to re-enter the personal identification code. If the match to the received code is found, then operational flow proceeds to prompt operation 418.

At prompt operation 418, the bridging platform prompts the caller to provide the destination telephone number. At number operation 419, the destination number is received for the calling party and is buffered. For this embodiment, the destination telephone number has not already been received via dual-stage dialing by the calling device. Had that been the case, then logical operations would skip to instruction operation 420 as the destination number would have already been buffered in memory.

Once the destination number is received, the bridging service then generates an instruction to the switch of the telecommunications network to place the outbound call to the destination number on behalf of the wireline account. The bridging platform also instructs the switch to bridge the outbound call together with the current call from the calling party at instruction operation 420. Upon the current call being bridged to the outbound call, the bridging platform is disconnected from the bridged call at disconnect operation 422. Then the bridging platform instructs the billing system of the use of the outbound call for the wireline account for the particular identification that has been received at operation 424. A record is then made for billing purposes by the billing system to indicate which identification (e.g., which MIN, ANI, or personal identification code) was used to authorize the call through the wireline account.

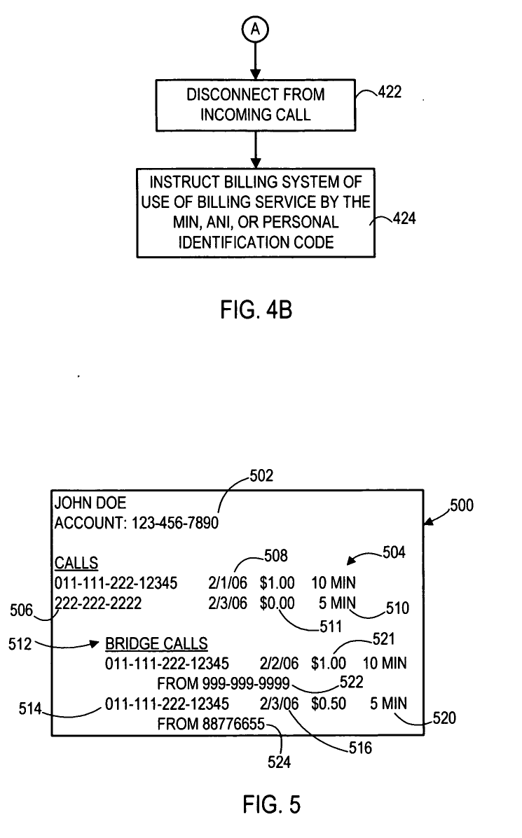

FIG. 5 shows an example of a billing statement 500 created by the billing system for the wireline account of the telecommunications system for which the bridging service is applicable. The wireline account is identified by the BTN 502. Section 504 lists the normal calls made through the wireline account, i.e., those calls actually placed from the telephone of the wireline account. The list of normal calls may include various pieces of information, including the destination number 506, the date of the call 508, the duration of the call 510, and the total charge of the call 511. Here it can be seen that the fee schedule for this wireline account provides for an international call at 10 cents per minute while there is no additional charge for domestic long distance calls.

Section 512 lists the calls completed by the bridging service using this particular wireline account. The list of these bridging service calls may include various pieces of information including the destination number 514, the date of the call 516, the duration of the call 520 and the total charge for the call 521. The total charge for the call is based on a fee schedule of this wireline account even though the caller is calling from a different account, such as a mobile phone account or a different wireline account.

The fee schedule of this wireline account for bridging service calls may be the same as the fee schedule used for normal calls of this wireline account, or may be different. For example, an increase in the fee may be provided for use of the bridging service to complete the call. As can be seen in this example, international calls have been made using the bridging service and the fee charged is the same as that for normally placed international calls. Application of the fee schedule to the bridging service calls utilizes parameters of the call to determine the fee as is done for the normal calls. Particularly, whether the call is a local, long distance, or international call is an example of one parameter. A surcharge-based duration of the call to the destination number is another example of a parameter. As noted above, the bridging fee schedule may specify a rate either on a per call basis or on a monthly recurring fee basis. The bridging fee schedule may specify one rate for long distance and another for international and may also specify a rate for local which may indicate that there is a local fee for bridging service calls. Furthermore, the bridging fee schedule may indicate that local calls through the bridging service are fee as they are when placed normally.

In addition to this information, the identification information used to authorize the use of the bridging service to employ this particular second account may be included. For example, the MIN or ANI 522 may be included for calls where the MIN or ANI was received and used to authorize the call. As another example, the personal identification code 524 may be included for calls where the MIN or ANI was not received or where an unrecognized MIN or ANI was received such that the personal identification code was necessary.

The bridging service may be setup in various ways. As noted above, an IVR 104 may be provided from the bridging platform to provide voice interaction with a user when desiring to setup a bridging service to a particular account. As another example, a web server 130 may provide a web site to allow the user to enter the setup information. The web server 130 may communicate with the client device 134 via hyper text transfer protocol or other networking protocols, may use secure socket layers, tunnels, or other forms of secure connections, and may provide web pages that are graphical or text based in nature so as to accommodate various types of user devices 134.

Examples of web pages of such a web site are shown in FIGS. 6A and 6B. In this example, the user logs on to a web address shown in the address bar 602 of screenshot 600 of FIG. 6A. The web page loads to present to the user a first data field 604 for entering the particular account that the bridging service will use to complete calls. The account ID to be entered in field 604 may be the ANI or MIN of the account to be used. To prevent unauthorized configuration of the bridging service, a security data field 606 may be presented to require that the user also enter a PIN for this account identified in data field 604. For this example, upon entering the account ID and PIN, the user may select a button 608 to enter this information and proceed to the next step.

After pressing the button 608, the web server 130 then provides a second web page shown in screenshot 610 of FIG. 6B. This screenshot also includes an address bar 612 but now includes data fields 614, 618, 622 for receiving entry of the ANIs and/or MINs that are valid for using the bridging service for the telecommunications account entered in field 604 of the previous page, If desired, the user may also utilize PIN data fields 616, 620, 624 to assign PINs to one or more of the valid ANIs and/or MINs that are being entered so that users of the valid ANIs or MINs must also know the appropriate PIN in order to utilize the bridging service.

To account for situations where the ANI or MIN is not passed to the bridging platform or where the user is calling from an unauthorized ANI or MIN, the user may specify a universal PIN in PIN field 626 so that the universal PIN may be requested by the bridging platform if the ANI or MIN is not passed or is not valid for the bridging service to allow the caller to have access to the bridging service.

Upon the caller completing entry of the ANIs, MINs, and/or PINs at screenshot 610, the user may then select the button 628 to have the data be accepted by the web server 130 and passed to the bridging platform 102 where the associations can then be added to the database 106 to thereby establish the bridging service.

While the invention has been particularly shown and described with reference to various embodiments thereof, it will be understood by those skilled in the art that various other changes in the form and details may be made therein without departing from the spirit and scope of the invention.

What is claimed is:

1. A computer readable medium containing instructions that perform acts comprising:
receiving an identification of a first account for a current telephone call;
performing a look-up of the identification within a table that relates the identification of the first account to a second telephone account;
determining a parameter of the current call; and
determining a fee for the current call based on the parameter and a fee schedule of the second account that relates parameters to fees.

2. The computer readable medium of claim 1, wherein the first account is a wireless telephone account and the second account is a wireline telephone account.

3. The computer readable medium of claim 1, wherein the parameter comprises duration of the current call.

4. The computer readable medium of claim 1, wherein the parameter comprises a destination of the current call.

5. The computer readable medium of clam 3, wherein the parameter further comprises an indication of whether the destination is a domestic local destination, domestic long distance destination, or an international long distance destination.

6. The computer readable medium of claim 1, wherein the acts further comprise:
receiving a personal identification code in addition to the identification of the first account for the current call, wherein performing the look-up further comprises looking up a stored personal identification code associated with the second telephone account;
determining whether the received personal identification code matches the stored personal identification code; and
completing the current call to a destination telephone number only when the received personal identification code matches the stored personal identification code.

7. The computer readable medium of claim 1, wherein the acts further comprise:
for a second telephone call, receiving a personal identification code as a substitute for an identification of the first account for the second telephone call;
performing a look-up of the personal identification code within the table that also relates the personal identification code to the second telephone account;
determining a parameter of the second call; and
determining a fee for the second call based on the parameter and the fee schedule of the second account that relates parameters to fees.

8. The computer readable medium of claim 1, wherein the acts further comprise:
generating a bill for the second telephone account, the bill comprising call charges for calls placed from the second telephone account and for calls placed from the first account that have been completed through the second telephone account.

9. A call processing platform, comprising:
a storage device comprising a table relating identification information to a second telephone account;
a processing system that receives identification information from an incoming telephone call placed from a first account, that looks-up the identification information within the table to find the corresponding second telephone account, that receives a destination number for the incoming call, that generates a request to complete the incoming call to the destination number upon finding the corresponding second telephone account, that monitors a parameter of the incoming call that is completed to the destination number, and that determines a fee for the incoming call that is completed to the destination based on the parameter and a fee schedule for the second telephone account.

10. The call processing platform of claim 9, wherein the first account is a wireless telephone account and wherein the second telephone account is a wireline telephone account.

11. The call processing platform of claim 9, wherein the identification information comprises a mobile identification number of a mobile communications device that placed the incoming call.

12. The call processing platform of claim 11, wherein the identification information further comprises a received personal identification code, and wherein the processing system looks-up a stored personal identification code of the wireline account and determines whether the received personal identification code matches the stored personal identification code and generates the request to complete the call only when the received personal identification code matches the stored personal identification code.

13. The call processing platform of claim 9, wherein the identification information comprises a telephone number of a wireline communications connection that is distinct from the wireline telephone account and from which the incoming call was placed.

14. The call processing platform of claim 13, wherein the identification information further comprises a received personal identification code, and wherein the processing system looks-up a stored personal identification code of the wireline account and determines whether the received personal identification code matches the stored personal identification code and generates the request to complete the call only when the received personal identification code matches the stored personal identification code.

15. The call processing platform of claim 9, wherein the parameter comprises duration of the current call.

16. The call processing platform of clam 9, wherein the parameter further comprises an indication of whether the destination is a domestic local destination, domestic long distance destination, or an international long distance destination.

17. The call processing platform of claim 9, further comprising a web server that provides a web interface that allows a user to enter data specifying the correspondence between at least the first account and the second account.

18. A computer readable medium containing instructions that perform acts comprising:
bridging a call from a phone line associated with a first account to a destination number;
associating the bridging of the call to the destination number with a second account different than the first account;
determining a parameter of the call; and
billing the second account associated with the bridging of the call based on the parameter and a fee schedule for calls placed from the second account.

19. The computer readable medium of claim 18, wherein the first account is a wireless telephone account and wherein determining the identification comprises receiving a mobile identification number of a wireless device from which the call is placed.

20. The computer readable medium of claim 18, wherein billing the wireline telephone account comprises generating a statement that lists calls made through the wireline telephone account and wherein the statement identifies the call made from the phone line associated with the first account.
